(19) United States
(12) Patent Application Publication
(10) Pub. No.: US 2025/0282906 A1
(43) Pub. Date: Sep. 11, 2025

(54) Protonated Covalent Organic Framework Material and Preparation Method and Use Thereof

(71) Applicants: TSINGHUA UNIVERSITY, Beijing (CN); BEIJING VFORTUNE NEW ENERGY POWER TECHNOLOGY DEVELOPMENT CO., LTD., Beijing (CN)

(72) Inventors: Hong XU, Beijing (CN); Xiangming HE, Beijing (CN); Jia CHEN, Beijing (CN)

(21) Appl. No.: 19/218,420

(22) Filed: May 26, 2025

Related U.S. Application Data
(63) Continuation of application No. PCT/CN2024/071932, filed on Jan. 12, 2024.

(30) Foreign Application Priority Data
Jan. 12, 2023 (CN) 2023100664270

(51) Int. Cl. C08G 12/08; C08G 73/06; C08G 83/00

(52) U.S. Cl. CPC C08G 12/08; C08G 73/06; C08G 83/008

(57) ABSTRACT

The disclosure provides a method for improving hydrogen adsorption performance of a covalent organic framework material, including the following steps: providing a covalent organic framework material including an imine bond; and placing the covalent organic framework material in hydrochloric acid vapor for protonation. The disclosure further provides a protonated covalent organic framework material, and use thereof as a hydrogen storage medium.

### TECHNICAL FIELD

The disclosure relates to the technical field of hydrogen storage materials, and in particular, to a protonated covalent organic framework material and a preparation method and use thereof.

### BACKGROUND

With the increase in demand and use of energy sources by humans, non-renewable energy resources such as fossil fuels (coal, petroleum, and natural gas) will be increasingly depleted. Large-scale development and utilization of renewable energy sources have become an important component in energy strategies of various countries in the world. Hydrogen energy, featuring rich sources, environmental-friendliness, renewability, high energy density, and the like, is the most ideal energy source in the future. The biggest technical obstacle to using hydrogen energy as a fuel is its storage. Hydrogen is gaseous at normal pressure and temperature, and its density is only 1/14 of that of air. A vehicle traveling 482.7 km (300 miles) requires about 5-13 kg of hydrogen, and at normal pressure and temperature, 5 kg of hydrogen occupies a volume of up to 56 m³. Apparently, the application of a hydrogen-powered vehicle needs a more practical and feasible hydrogen storage method.

At present, many hydrogen storage methods have been proposed. The most common methods include a compressed gas storage method and a liquid hydrogen storage method. Although these methods are easily achieved and technically mature, they each have shortcomings that are difficult to overcome. For example, there is a certain danger in the storage and transportation of high-pressure gaseous hydrogen with a steel cylinder. Because hydrogen may be dissolved and permeate into a steel wall at high pressure, resulting in a hydrogen embrittlement phenomenon of the storage steel cylinder. This brings huge potential safety hazards to long-term hydrogen storage and a small hydrogen storage capacity and a high cost as well. The density of liquid hydrogen is higher than that of gaseous hydrogen. But the storage temperature of liquid hydrogen is −252.8° C., which means that substantial energy needs to be consumed and good thermal insulation equipment is needed during storage. Therefore, the requirement for the device is relatively high, and the cost is high. Therefore, it is extremely important to seek for a novel hydrogen storage material and storage method, and a porous material has recently emerged as a major research focus.

Adsorption is a phenomenon in which a gas partially retained upon contact with a solid. It is divided into two major categories: chemisorption and physisorption according to different acting forces, adsorption heat, adsorption speeds, selectivity, adsorption temperatures, pressures, and the like. The main chemical hydrogen storage materials are metal hydrides. Chemisorption is usually related to activation energy, which means that to adsorb molecules attracted to the surface, the molecules must pass through an energy barrier before being tightly bound to the surface. Therefore, most chemisorption processes have relatively high reaction activation energy, the desorption process is slow, and some metal hydrides are even non-renewable. In contrast, physisorption hydrogen storage means that gas molecules accumulate on the surface of a material but are not chemically reacted with the material, and gas is adsorbed and stored by means of the intermolecular interaction of the gas and the material. Due to a weak acting force between the hydrogen molecules and the pore surfaces of an adsorbent, physisorption hydrogen storage has rapid adsorption and desorption dynamics, typically operating at lower temperatures and higher pressures. Main physisorption hydrogen storage materials include porous materials such as zeolite, activated carbon, a nanotube, a metal organic framework, and the like.

Metal-organic frameworks (MOFs) materials and covalent organic framework (COF) materials both are crystalline porous materials that have been developed rapidly in recent years. The MOF is a type of three-dimensional network structure crystals mainly formed by hybridizing nitrogen and oxygen porous organic ligands of aromatic acid or alkali with an inorganic metal center through coordination bonds. Therefore, it is also known as a porous coordination polymer (PCP). Due to pore structural similarity to zeolites but with a flexible framework, it is also known as “soft zeolite”. The first-generation MOF material was synthesized in the middle of the 1990s, and the pore structure of the MOF material at that time still needs to be supported by guest molecules. If the guest molecules are removed, the framework will collapse, resulting in an unstable pore structure. Soon afterward, researchers begin to assemble anions, cations, and neutral ligands into a coordination polymer, thereby synthesizing a new-generation MOF material. Organic ligands of this type of MOF materials are mainly based on carboxyl-containing organic anions and are sometimes mixed with nitrogen-containing heterocyclic organic neutral ligands. The MOF materials of this generation make up for the deficiencies of the previous generation. When the guest molecules are introduced or removed, or a certain external stimulation (for example, pressure, and the like) is applied, the framework structure of the material will have a certain change but does not collapse. The COF material is a type of novel framework structure synthesized in recent years, which may have one-dimensional, two-dimensional, and three-dimensional different crystalline structures. There are only organic matter structural units in the frameworks of this type of materials, and they are linked through strong covalent bonds (for example, C—C, C—B, and B—O). Three materials COF-6, COF-8, and COF-10 are of layered two-dimensional structures like graphite. Another three materials COF-102, COF-105, and COF-108 are materials with three-dimensional structures formed by introducing triangular and tetrahedral nodes. This type of materials has the advantages of large porosity and specific surface area and good thermal stability, and being easy to functionalize. Compared with the MOFs material, the COF material is lower in crystalline density, such that the COF material is expected to be more effectively applied to gas storage. Moreover, the covalent bonds connecting COF building units are more stable than the coordination bonds of the MOF, such that the material has higher stability and potential for further modification.

At present, for a physical hydrogen storage material, the MOF/COF material mainly improves the hydrogen storage performance from the angle of increasing its specific surface area and pore volume.

For example, MOF-5 is a typical example among many MOF compounds. Its framework [Zn₄O(bdc)₃] is a three-dimensional network with pcu topology formed by interconnecting Zn₄O (—COO)₆ units and terephthalate bdc²—. The patent WO2005003622A1 discloses a hydrogen storage container with an MOF-5 material. At a pressure of 3 bar, the hydrogen storage weight of the container with the MOF-5, compared with a container without the MOF-5 is increased by 1.46 times.

For the physical hydrogen storage material, there is a contradiction between high specific surface area and material stability. The MOF/COF materials with high specific surface area are often prepared by means of highly reversible reactions (for example, boric acid in COF, three-dimensional boric COF, with BET reaching −5000). However, this means they have stronger decomposition tendencies (poor chemical stability). Second, for the MOF/COF materials with high specific surface area, the collapse of pores is also an unavoidable problem. For example, the activation process of MOF with BET specific surface area exceeding 5000 m²/g is often complicated and requires methods such as supercritical CO₂. Therefore, it can be seen that there are problems in either chemical stability or collapse of pore structures in the case of excessively high specific surface area. In addition, the current MOF materials with the specific surface area of 7200 still cannot satisfy the requirement of the United States Department of Energy for the hydrogen storage density of hydrogen storage system. Therefore, seeking for a way except beyond increasing the BET specific surface area is the direction worth exploring for MOF/COF physical hydrogen storage materials. Further regulation of adsorption heat based on further adsorption of the COF materials with high specific surface area is a good starting point. However, to realize the regulation of adsorption heat at the material level still needs systematic exploration.

The combination of characteristics of the physical hydrogen storage materials and the chemical hydrogen storage material is the key to developing efficient hydrogen storage materials, which is a big challenge in the field of hydrogen storage. Aiming at hydrogen storage characteristics required in hydrogen storage and transportation, at present, it is also needed to combine the high absorption thermal characteristic of the chemical hydrogen storage materials with the low adsorption thermal characteristic of the porous physical hydrogen storage materials in the scientific field, i.e., regulate the intra-pore environment of the porous material to improve the interaction thereof on hydrogen molecules.

### SUMMARY

In order to solve the technical problems described above, the inventor found that significant improvement of hydrogen adsorption heat and hydrogen storage capacity of covalent organic framework compounds may be realized by protonation of COF. By selecting imine-linked COF with excellent stability, imine bonds are protonated by vapor treatment with hydrochloric acid vapor to improve the adsorption heat at imine sites, so that the hydrogen storage capacity of COF can be intensified.

A first aspect of the disclosure provides a protonated covalent organic framework material, where the covalent organic framework material has a structure shown in formula (I):

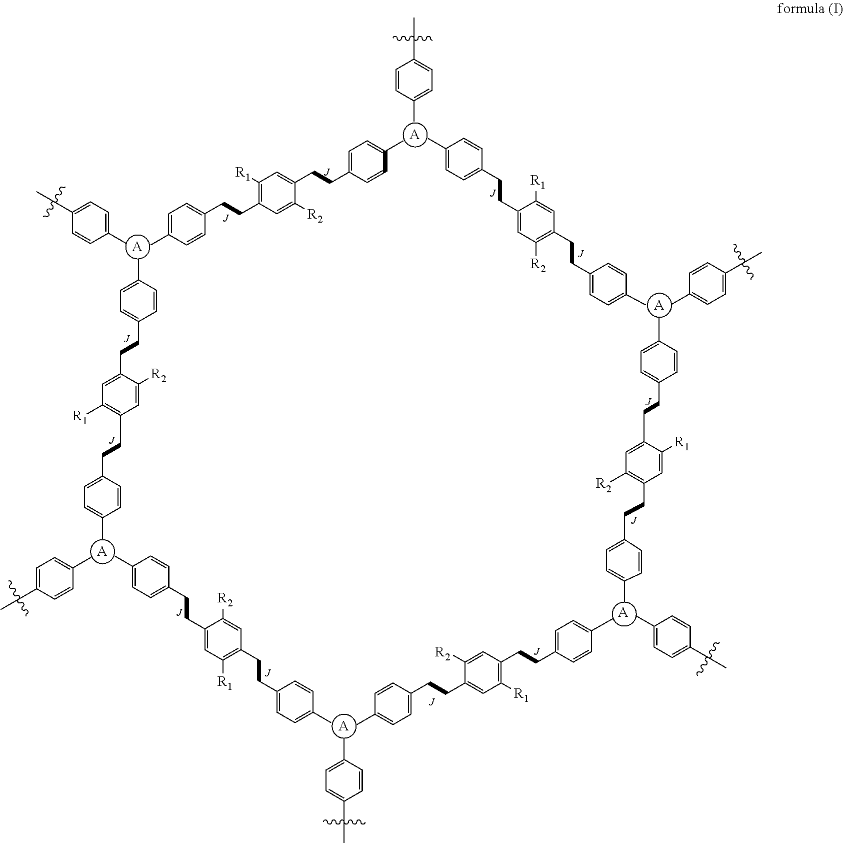

where
R₁ and R₂ each are independently selected from H, C₁-C₆ alkyl, methoxyl, and ethoxyl; A is a six-membered aromatic ring or heteroaromatic ring; and
J is a protonable site, and
one or more J have been protonated.

A second aspect of the disclosure provides a method for improving hydrogen adsorption performance of a covalent organic framework material, including the following step: protonating the covalent organic framework material containing an imine bond with hydrochloric acid vapor.

Another aspect of the disclosure includes use of the protonated covalent organic framework material described above or the covalent organic framework material obtained by the method described above as a hydrogen storage medium.

The disclosure has the following beneficial effects:
1. Modification treatment on the hydrogen storage material in the prior art is usually to improve the hydrogen storage performance of the material by increasing the specific surface area of the material or doping the material, which is complicated to operate and high in cost. However, in the disclosure, the hydrogen adsorption performance of the imine covalent organic framework is improved through simple protonation, which contributes to solving the problem that the existing hydrogen storage material is low in hydrogen storage capacity.
2. Low adsorption heat of the covalent organic framework compound in the prior art obstructs its wide promotion and application as the hydrogen storage medium. The disclosure provides a simple protonation method, which improves the hydrogen storage capacity of the material by improving the adsorption heat of the porous physical hydrogen storage material, thereby contributing to promoting the actual application and development of the covalent organic framework in the field of hydrogen storage.
3. The method provided by the disclosure is universal and shows a good implementation effect on covalent organic frameworks with different structures.
4. Modification methods on the hydrogen storage material in the prior art all are limited to microgram-level laboratory scale. The method provided by the disclosure can realize amplified preparation, which contributes to industrial application.

### BRIEF DESCRIPTION OF FIGURES

FIG. 1 is a schematic diagram of a preparation process of a protonated covalent organic framework material according to the disclosure.

FIG. 2 shows an X-ray diffraction (XRD) pattern of the covalent organic framework material before and after protonation.

FIG. 3 shows an infrared spectrum of the covalent organic framework material before and after protonation.

FIG. 4 shows a hydrogen adsorption-desorption isotherm of the covalent organic framework material before and after protonation.

FIG. 5 shows a curve graph of hydrogen adsorption capacity vs pressure (bar) of the covalent organic framework material before and after protonation.

### DETAILED DESCRIPTION

As used herein, the terms covalent organic framework, covalent organic skeleton, and COF may be interchangeable.

The terms “protonation” and “acidification” may be interchangeable, which means that protons (positively charged hydrogen ions) are bound to protonable sites of a compound.

The term “protonable sites” refers to electron-donating groups in the compound and may be bound to the protons in acid for protonation.

Besides, unless otherwise defined, it should be understood that all the terms used in the specification have the same meaning usually understood by a person skilled in the art.

To make the technical solutions and advantages of the disclosure clearer and easier to understand, the disclosure will be clearly and completely described below in conjunction with specific embodiments and drawings. It should be noted that the embodiments or technical features described below may be freely combined to form novel embodiments without conflicts.

It should also be noted that in the disclosure, words such as “exemplary” or “for example” are used to represent examples, illustrations or descriptions. Any embodiments or design solutions described as “exemplary” or “for example” in the disclosure should not be interpreted as more preferable or advantageous than other embodiments or design solutions. To be extract, the use of words such as “exemplary” or “for example” aims to represent related concepts in a specified manner.

In the disclosure, “at least one” refers to one or more, and “a plurality of” refers to two or more. “And/or” describes an associated relationship of associated objects, representing there may be three relationships. For example, A and/or B may represent A alone, both A and B, and B alone, where A and B may be single or plural. “at least one of the following” or similar expressions refer to any combination of these items, including any combination of a single item or plural items. For example, at least one of a, b, or c may represent: a, b, c, a and b, a and c, b and c, and a and b and c, where there may be one or more a, b, and c. It is worth noting that “at least one” may also be interpreted as “one or more”.

As described above, the disclosure provides a protonated covalent organic framework material, where the covalent organic framework material has a structure shown in formula (I), where J is a protonable site. The protonable site is a group capable of protonating. Preferably, J is an imine bond, and the C atom of each imine bond is connected to a benzene ring containing R₁ and R₂ in formula (1).

According to the protonated covalent organic framework material provided in the disclosure, the protonation is realized by making the covalent organic framework material contact with hydrochloric acid vapor. The hydrochloric acid vapor refers to a hydrogen chloride gas obtained after concentrated hydrochloric acid is volatilized, and the hydrogen chloride gas is substantially free of or free of water molecules.

The term “substantially free water molecules” herein means that water molecules of gas in a mixture of the hydrogen chloride gas and the water molecules of gas are less than 7 volume %, preferably 3 volume %, and more preferably 1 volume %.

According to the protonated covalent organic framework material provided in the disclosure, A in the structure shown in formula (I) is a benzene ring or s-triazine ring.

According to the protonated covalent organic framework material provided in the disclosure, R₁ and R₂ in the structure shown in formula (I) each may be independently selected from —H, alkyl, hydroxyalkyl, and alkoxyl; preferably, R₁ and R₂ each may be independently selected from —H, C₁-C₆ alkyl, C₁-C₆ hydroxyalkyl, and C₁-C₆ alkoxyl; more preferably, R₁ and R₂ each may be independently selected from —H, methyl, ethyl, isopropyl, isobutyly, tert-butyl, methoxyl, ethoxyl, hydroxyisopropyl, and hydroxyethyl; and most preferably, R₁ and R₂ are methoxyl.

The disclosure further provides a method for improving hydrogen adsorption performance of a covalent organic framework material, including the following step: protonating the covalent organic framework material containing an imine bond with hydrochloric acid vapor.

The protonation may be realized by placing the covalent organic framework material in hydrochloric acid vapor or introducing the hydrochloric acid vapor into the covalent organic framework material as long as the covalent organic framework material is in contact with the hydrochloric acid vapor at a proper time. For example, concentrated hydrochloric acid with a certain concentration may be placed in a drier loaded with photochromic silicon spheres at normal temperature and pressure, so that the volatilized hydrogen chloride gas is in contact with the covalent organic framework material. For example, the concentrated hydrochloric acid has a concentration over 20 wt %, preferably, a concentration of 36 wt % to 38 wt %, and more preferably, a concentration of 37 wt %.

In the method provided by the disclosure, the hydrochloric acid vapor refers to a hydrogen chloride gas obtained after concentrated hydrochloric acid is volatilized, and the hydrogen chloride gas is substantially free of or free of water molecules. In the preferred embodiment of the disclosure, the water molecules in the hydrogen chloride gas obtained after the concentrated hydrochloric acid is volatilized are substantially adsorbed by a drying agent. Therefore, the hydrochloric acid vapor is the hydrogen chloride gas which is substantially free of water molecules. The drying agent may be a common drying agent in the art that is not reacted with the hydrogen chloride gas. For example, the drying agent is selected from any one of calcium chloride, silica gel, silicon tetrachloride, phosphorus pentoxide, or concentrated sulfuric acid. Through intensive studies, the inventor unexpectedly found that the protonated covalent organic framework material obtained by performing protonation with hydrochloric acid vapor has a larger pore volume and specific surface area and better gas adsorption performance. If a hydrochloric acid aqueous solution is used to treat the COF, the reaction process is too violent. On the one hand, there will be a lot of hydrogen chloride molecules and water molecules in the pore channels of the COF, which results in a sudden decrease of the pore volume and specific surface area of the material and a remarkable reduction of the gas adsorption performance. On the other hand, the water molecules will be adsorbed in the pore channels of the COF and are difficult to remove. If they are dried, the water molecules and hydrogen chloride molecules are removed together, so that the protonation effect is lost. Therefore, the use of the hydrochloric acid vapor containing a small amount of water molecules or substantially free water molecules in the range of the disclosure for protonation is advantageous.

In the method provided by the disclosure, the time for the protonation is preferably 30-180 min, and more preferably 45-120 min, for example, 35 min, 40 min, 45 min, 50 min, 52 min, 54 min, 56 min, 58 min, 60 min, 62 min, 64 min, 66 min, 68 min, 70 min, 72 min, 74 min, 76 min, 78 min, 80 min, 85 min, 90 min, 95 min, 100 min, 105 min, 110 min, 115 min, 120 min, 130 min, 140 min, 150 min, 160 min, and 170 min. A person skilled in the art may adjust the time for the protonation within the above range according to the used COF material to prevent an insufficient protonation degree due to an excessively short treatment time and damage to the structure of the COF material which may be caused by an excessively long treatment time.

According to the method provided by the disclosure, the covalent organic framework material containing an imine bond is prepared by reacting a polyamino monomer and a polyaldehyde monomer as reactants in a mixed solvent under the catalyzing by a catalyst. Under normal conditions, the reaction is performed at 100-150° C., preferably at 100-130° C., more preferably, at 110° C., 112° C., 114° C., 116° C., 118° C. or 120° C., and most preferably, at 120° C.

According to the method provided by the disclosure, the polyamino monomer is a compound containing two or more amino groups. For example, the polyamino monomer may be selected from ethanediamine, diethylenetriamine, triethylene tetramine, tetraethylene pentaamine, pentaethylene hexamine and other polyenepolyamines, p-phenylenediamine, triaminobenzene, other polyamino aromatic compounds, a diamino heterocyclic compound, a triamino heterocyclic compound or a polyamino heterocyclic compound. Preferably, the polyamino compound is 1,3,5-tri (4-aminophenyl)benzene.

According to the method provided by the disclosure, the polyaldehyde monomer is a compound containing two or more aldehyde groups. For example, the polyaldehyde monomer is selected from one of substituted or unsubstituted terephthalaldehyde, substituted or unsubstituted biphenyldicarboxaldehyde, and substituted or unsubstituted thiophenedicarbaldehyde.

Preferably, the polyaldehyde monomer is substituted terephthalaldehyde. More preferably, the polyaldehyde monomer is 2,5-dimethoxyterephthalaldehyde.

According to the method provided by the disclosure, the catalyst may be selected from any catalyst known in the art. For example, the catalyst may be selected from one or more of formic acid, acetic acid, p-toluenesulfonic acid, oxalic acid, lactic acid, hydrochloric acid, sulfuric acid, and pyrrolidine. Preferably, the catalyst is selected from acetic acid.

According to the method provided by the disclosure, the mixed solvent may be selected from any mixed solvent known in the art. For example, the mixed solvent may be any one of ethylene glycol+cyclohexane, mesitylene+dioxane, n-butanol+dioxane, o-dichlorobenzene+n-butanol, and mesitylene+n-butanol. In the mixed solvent, the volume ratio of the former to the latter is 9:1 to 1:9, for example, 5:1 to 1:5, 3:1 to 1:3. Preferably, the volume ratio of the two liquids is 1:1.

Preferred conditions of the disclosure are further described below in conjunction with embodiments and drawings. It should be understood that the preferred embodiments described herein are merely used for describing and explaining the disclosure, rather than limiting the disclosure.

Raw materials or reagents used in the embodiments below all are marketed or self-made.

### Example 1

### (Preparation of an Imine Covalent Organic Framework)

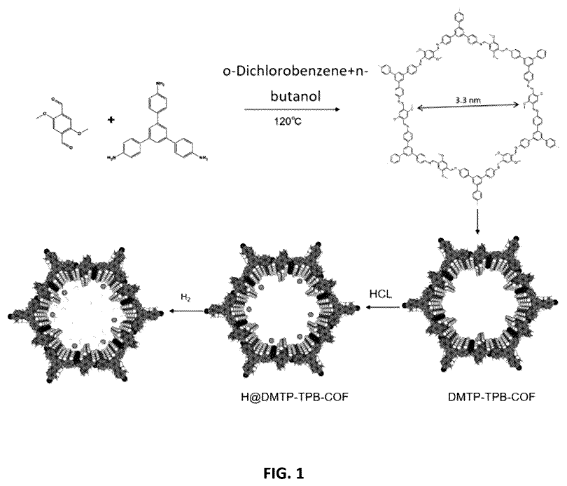

In a mixed solvent of orthodichlorobenzene (o-DCB)+normal butanol (BuOH) (1 mL, volume ratio: 1:1), 1,3,5-tri (4-aminophenyl)benzene (TPB) (0.1 mmol) and 2,5-dimethoxyterephthalaldehyde (DMTP) (0.15 mmol) were added and dissolved in the mixed solvent to obtain a mixture. Acetic acid (6 mol/L, 0.1 mL) was added into the mixture, and the mixture was heated to and maintained at 120° C. for reaction for 3 days. A reaction product was filtered, washed, and purified to obtain the imine covalent organic framework, named DMTP-TPB-COF. See FIG. 1.

### (Preparation of a Protonated Imine Covalent Organic Framework)

The protonated imine covalent organic framework was prepared by hydrochloric acid vapor. At normal temperature and pressure, a hydrochloric acid solution with a concentration of 37 wt % was placed in a drier loaded with photochromic silicon spheres, and then the prepared DMTP-TPB-COF was placed in the drier for 60 min to obtain the protonated COF, named H@DMTP-TPB-COF. See FIG. 1.

### Effect Determination

### (Crystalline Structure Analysis and Chemical Composition Determination)

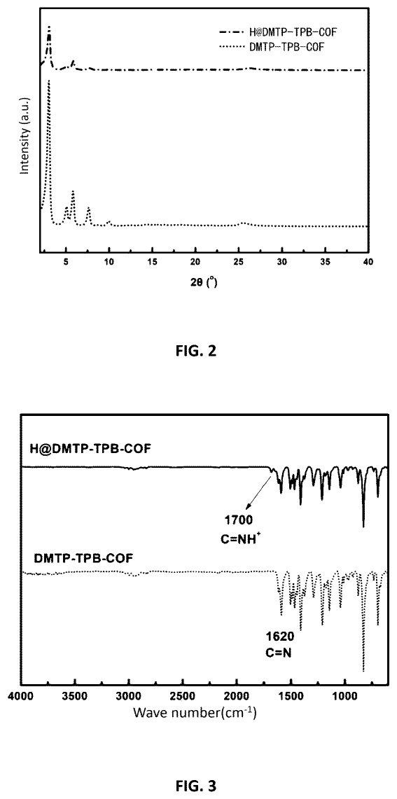

The crystalline structure of the material is analyzed by using powder crystalline X-ray diffraction (XRD), and the chemical composition of the material is analyzed by infrared rays. As shown in FIG. 2, the powder crystalline X-ray diffraction (XRD) results of DMTP-TPB-COF and H@DMTP-TPB-COF verify that protonation has no significant influence on the crystalline structure of the COF material. It may be seen with reference to FIG. 3 that after the protonation, the imine bonds are successfully protonated.

### (BET Specific Surface Area Determination and Hydrogen Storage Capacity Determination)

BET specific surface area determination and hydrogen storage capacity determination are performed on the obtained covalent organic framework compound by using a gas adsorption instrument.

The used normal pressure gas adsorption instrument is BELSORP-maxll manufactured by MicrotracBEL.

The used high pressure hydrogen adsorption instrument is a HPVA-100 high pressure volume analyzer manufactured by MICROMERITICS INSTRUMENT CORPORATION.

A determination method for the BET specific surface area is as follows: determined by an N₂ adsorption isotherm of 77 K, the surface area of the material is calculated by using a BET (Brunauer-Emmett-Teller) equation.

A determination method for the hydrogen storage capacity at 77K-normal temperature is as follows: an adsorption isotherm of hydrogen is acquired by a dynamic volumetric method using a normal pressure gas adsorption analyzer.

A determination method for the hydrogen storage capacity at 77K-high temperature is as follows: a high pressure adsorption isotherm of hydrogen is acquired by a static volumetric method using a high pressure gas adsorption analyzer.

The determined BET specific surface area, the hydrogen storage capacity at 77K-normal pressure, and the hydrogen storage capacity at 77K-high pressure (80 bar) are shown in Table 1.

TABLE 1

| | | Hydrogen | | |
|---|---|---|---|---|
| | | storage | Hydrogen | Hydrogen |
| | | capacity at | storage | storage |
| | BET specific | 77K-normal | capacity at | capacity at |
| | surface area | pressure | 77K-40 bar | 77K-80 bar |
| Compound | (m³/g) | (wt %) | (wt %) | (wt %) |
| H@DMTP-TPB-COF | 1630 | 1.11 | 4.19 | 5.01 |
| DMTP-TPB-COF | 1880 | 0.84 | 3.43 | 3.52 |

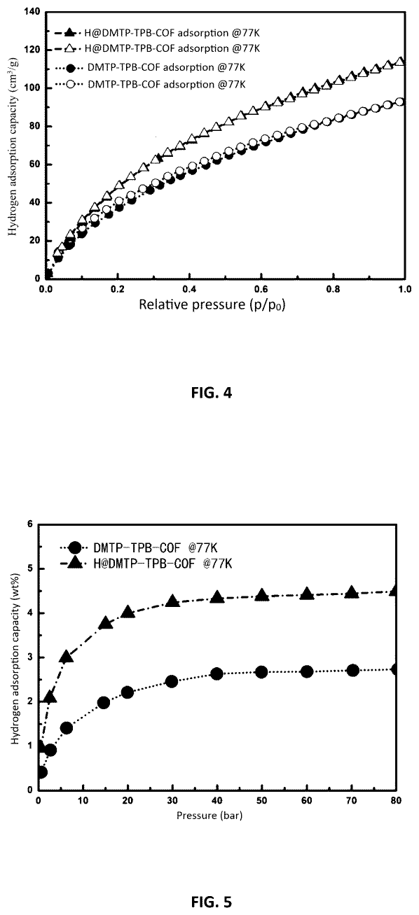

The inventor found that after the protonation, due to the introduction of protons, the specific surface area of the COF is decreased to a certain extent. However, surprisingly, due to the protonation of the imine bonds, the adsorption heat of the imine sites is increased, so that the hydrogen storage capacity of the COF is significantly improved. It can be seen with reference to the normal pressure hydrogen adsorption-desorption isotherm in FIG. 4 and the hydrogen adsorption capacity-pressure curve in FIG. 5 that the hydrogen adsorption capacity of the H@DMTP-TPB-COF is far higher than that of the DMTP-TPB-COF at either the normal pressure or the high pressure. Thus, it can be seen that the protonation improves the hydrogen adsorption performance of the covalent organic framework material, which is a simple and highly universal strategy for effectively improving the hydrogen storage performance of the covalent organic framework material.

What is claimed is:

1. A covalent organic framework material, wherein the covalent organic framework material has a structure shown in formula (I): 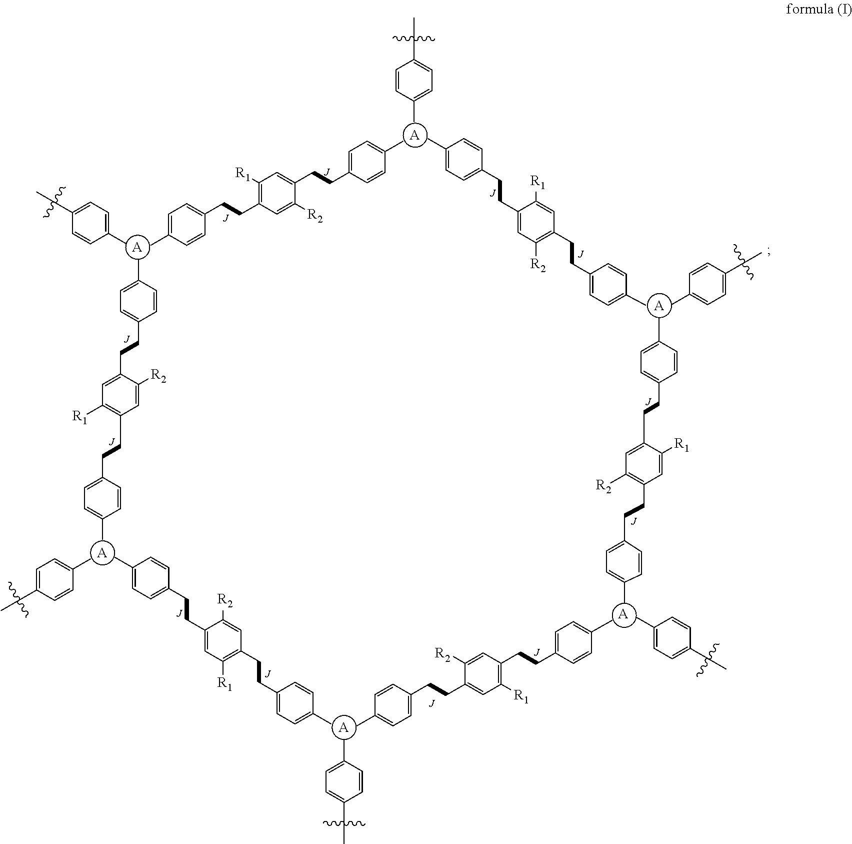
wherein
R₁ and R₂ each are independently selected from —H, C₁-C₆ alkyl, C₁-C₆ hydroxyalkyl, and C₁-C₆ alkoxyl;
A is a six-membered aromatic ring or heteroaromatic ring; and
J is a protonable site, and
one or more J have been protonated.

2. The covalent organic framework material according to claim 1, wherein J is an imine bond, and the C atom of each of the imine bonds is connected to a benzene ring containing R₁ and R₂ in formula (I).

3. The covalent organic framework material according to claim 1, wherein A is a benzene ring or s-triazine ring.

4. The covalent organic framework material according to claim 1, wherein R₁ and R₂ each are independently selected from —H, methyl, ethyl, isopropyl, isobutyl, tert-butyl, methoxyl, ethoxyl, hydroxyisopropyl, and hydroxyethyl.

5. A method for improving hydrogen adsorption performance of the covalent organic framework material of claim 1, comprising the following step: protonating the covalent organic framework material containing an imine bond with hydrochloric acid vapor.

6. The method according to claim 5, wherein the covalent organic framework material containing an imine bond has a structure shown in formula (I): 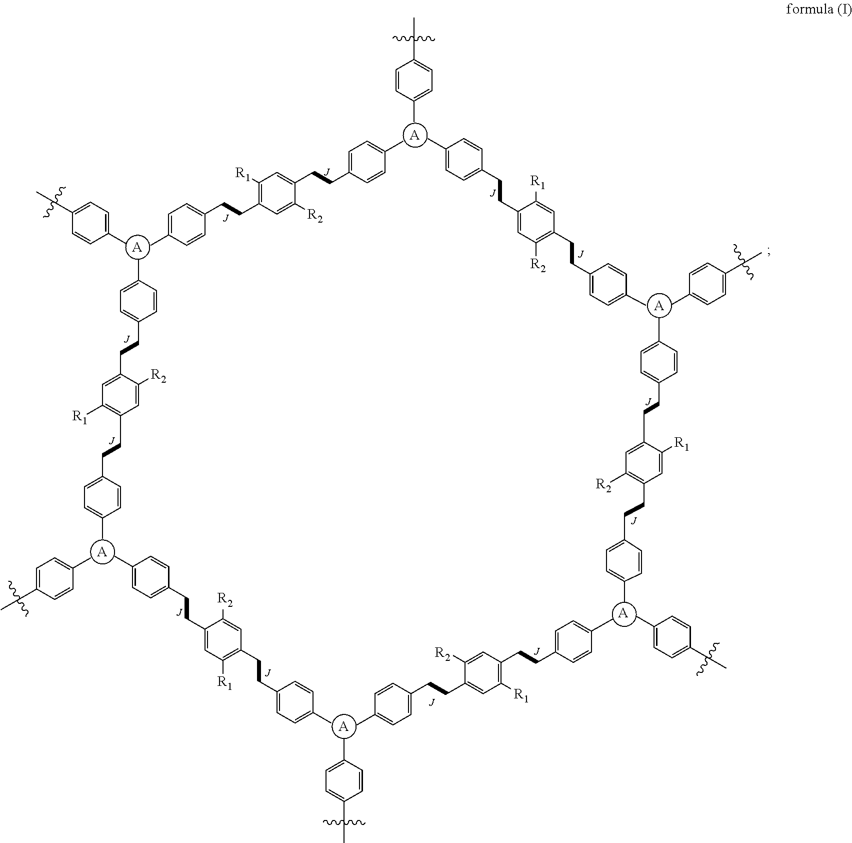
wherein
R₁ and R₂ each are independently selected from H, C₁-C₆ alkyl, methoxyl, and ethoxyl;
A is a six-membered aromatic ring or heteroaromatic ring; and
J is an imine bond, and the C atom of each of the imine bonds is connected to a benzene ring containing R₁ and R₂ in formula (I).

7. The method according to claim 6, wherein A is a benzene ring or s-triazine ring.

8. The method according to claim 6, wherein R₁ and R₂ are methoxyl.

9. The method according to claim 5, wherein the time for the protonation is 30-180 minutes.

10. The method according to claim 5, wherein the covalent organic framework material containing an imine bond is prepared by reacting a polyamino monomer and a polyaldehyde monomer as reactants in a mixed solvent under the catalyzing by a catalyst.

11. The method according to claim 10, wherein the reaction is performed at 100-150° C.

12. The method according to claim 5, wherein the hydrochloric acid vapor is obtained by volatilization of concentrated hydrochloric acid.

13. The method according to claim 5, wherein the hydrochloric acid vapor is a hydrogen chloride gas obtained by volatilizing concentrated hydrochloric acid followed by drying with a drying agent, and the hydrogen chloride gas is substantially free of or free of water molecules.
